(19) United States
(12) Patent Application Publication
(10) Pub. No.: US 2019/0071056 A1
(43) Pub. Date: Mar. 7, 2019

(54) VEHICLE AND CONTROL METHOD THEREOF

(71) Applicants: Hyundai Motor Company, Seoul (KR); Kia Motors Corporation, Seoul (KR)

(72) Inventor: Hyunwoo Choi, Gunpo (KR)

(21) Appl. No.: 15/833,548

(22) Filed: Dec. 6, 2017

(30) Foreign Application Priority Data
Sep. 7, 2017 (KR) 10-2017-0114490

(51) Int. Cl. B60R 25/34; B60R 25/33; H04L 29/06

(52) U.S. Cl. CPC B60R 25/34; H04L 67/12; H04L 63/1416; B60R 25/33

(57) ABSTRACT

A vehicle may include a detector detecting a state of the vehicle; and a controller determining whether a vehicle intrusion is detected based on the detected state of the vehicle. The controller determines whether the vehicle intrusion is detected according to a predetermined intrusion detection item corresponding to the state of the vehicle

### CROSS-REFERENCE TO RELATED APPLICATION

This application claims the benefit of priority to Korean Patent Application No. 10-2017-0114490, filed on Sep. 7, 2017 in the Korean Intellectual Property Office, the disclosure of which is incorporated herein by reference in its entirety as if fully set forth herein.

### BACKGROUND

### 1. Technical Field

Embodiments of the present disclosure relate to a vehicle and a control method thereof, and more particularly, to a technology capable of detecting a vehicle intrusion using different methods based on a current state of the vehicle.

### 2. Description of Related Art

As the number of vehicles has increased, so to have problems such as vehicles being stolen or hacked. Thus, programs for preventing such intrusions have been developed.

For example, an intrusion detection system (IDS) is a system configured to detect an action inhibiting the integrity, the confidentiality, and/or the availability of the vehicle computer system, and then respond the inhibition in real-time. The IDS is able to detect behavior that is not permitted by the system or abnormal behavior. The IDS is further able, to block the intrusion in real-time by distinguishing the detected illegal behavior. In addition, the IDS protects the security of the vehicle by detecting and recording behavior of an internal network. When an abnormal situation occurs, the abnormal situation is immediately recognized and a corresponding packet generating the illegal behavior is blocked.

However, since a network firewall or IDS system i is operated on a personal computer or a server which have relatively high process performance, it may be inefficient to apply a conventional network firewall and IDS to the vehicle environment which has a relatively low performance. Thus, it may be not suitable in terms of resource utilization.

In addition, when using an IDS in a vehicle, operation may depend on a power state, an ignition state, and a driving state of the vehicle. But a conventional IDS may apply a uniform standard without considering those characteristics of the vehicle, causing the IDS to be inefficient.

### SUMMARY

Therefore, it is an aspect of the present disclosure to provide a vehicle capable of efficiently determining whether a vehicle intrusion is detected by actively changing an intrusion detection item based on a variety of states of the vehicle, and a control method of thereof.

Additional aspects of the present disclosure will be set forth in part in the description which follows and, in part, will be apparent from the description, or may be learned by practice of the present disclosure.

According to embodiments of the present disclosure, a vehicle includes: a detector detecting a state of the vehicle; and a controller determining whether a vehicle intrusion is detected based on the detected state of the vehicle. The controller determines whether the vehicle intrusion is detected according to a predetermined intrusion detection item corresponding to the state of the vehicle.

The controller may determine whether the vehicle intrusion is detected, according to at least one of a network item, a telematics item, and a wireless update item when the power of the vehicle is turned off.

The controller determine whether the vehicle intrusion is detected, according to the telematics item when a battery power value of the vehicle is less than a first power value.

The controller may determine whether the vehicle intrusion is detected based on an engine state of the vehicle.

The controller determines whether the vehicle intrusion is detected, according to at least one of a wireless network item, a telematics item, a wireless update item, and an in-vehicle communication item when the engine of the vehicle is turned on by a remote ignition.

The controller determines whether the vehicle intrusion is detected, based on at least one of a battery state of the vehicle and a state of an audio, video, navigation (AVN) device when the vehicle is in an accessory (ACC) state.

The controller may determine whether the vehicle intrusion is detected, according to at least one of a wireless network item, a telematics item, a wireless update item, and an item related to an external device connected to the vehicle when the battery power value of the vehicle is higher than a second power value.

The controller may determine whether the vehicle intrusion is detected, according to at least one of an item related to an external device connected to the vehicle and a vehicle item when the communication of the AVN device of the vehicle is not available.

The controller may not determine whether the vehicle intrusion is detected when the vehicle is in a remote service ready mode after the power of the vehicle is turned off, or when the battery power value of the vehicle is less than a third power value while the vehicle is in the ACC state.

The vehicle may further include a communicator informing a user of the vehicle or a telephone management system (TMS) control center of the vehicle intrusion when it is determined by the controller that the vehicle intrusion is detected.

Furthermore, according to embodiments of the present disclosure, a control method of a vehicle includes: detecting, by a detector, a state of the vehicle; and determining, by a controller, whether a vehicle intrusion is detected based on the detected state of the vehicle. The determination of whether the vehicle intrusion is detected comprises determining whether the vehicle intrusion is detected, according to a predetermined intrusion detection item corresponding to the state of the vehicle.

The determination of whether the vehicle intrusion is detected may include determining whether the vehicle intrusion is detected, based on a power state of the vehicle.

The determination of whether the vehicle intrusion is detected may include, when the power of the vehicle is turned off, determining whether the vehicle intrusion is detected, according to at least one of a network item, a telematics item, and a wireless update item.

The determination of whether the vehicle intrusion is detected may include determining whether the vehicle intrusion is detected, according to the telematics item of the vehicle when the battery power value of the vehicle is less than a first power value.

The determination of whether the vehicle intrusion is detected may include determining whether the vehicle intrusion is detected based on an engine state of the vehicle.

The determination of whether the vehicle intrusion is detected may include, when an engine of the vehicle is turned on by a remote ignition, determining whether the vehicle intrusion is detected, according to at least one of a wireless network item, a telematics item, a wireless update item, and an in-vehicle communication item.

The determination of whether the vehicle intrusion is detected may include determining whether the vehicle intrusion is detected, based on at least one of a battery state of the vehicle and a state of an audio, video, navigation (AVN) device when the vehicle is in an accessory (ACC) state.

The determination of whether the vehicle intrusion is detected may include, when a battery power value of the vehicle is higher than a second power value, determining whether the vehicle intrusion is detected according to at least one of a wireless network item, a telematics item, a wireless update item, and an item related to an external device connected to the vehicle.

The determination of whether the vehicle intrusion is detected may include determining whether the vehicle intrusion is detected, according to at least one item of the item related to an external device connected to a system of the vehicle and the vehicle when the communication of the AVN device of the vehicle is not available.

The determination of whether the vehicle intrusion is detected may include, when communication of an AVN device of the vehicle is not available, determining whether the vehicle intrusion is detected according to at least one of an item related to an external device connected to the vehicle and a vehicle item.

### BRIEF DESCRIPTION OF THE DRAWINGS

These and/or other aspects of the disclosure will become apparent and more readily appreciated from the following description of embodiments, taken in conjunction with the accompanying drawings briefly discussed below.

FIG. 1 is view illustrating an exterior of a vehicle in accordance with embodiments of the present disclosure.

FIG. 2 is a view illustrating an interior of the vehicle in accordance with embodiments of the present disclosure.

FIG. 3 is a block diagram illustrating a part of the configuration of the vehicle 1 in accordance with embodiments of the present disclosure.

FIG. 4 is a table illustrating an item to determine whether the vehicle intrusion is detected in accordance with embodiments of the present disclosure.

FIG. 5 is a flow chart illustrating a control method of the vehicle in accordance with embodiments of the present disclosure.

FIGS. 6 to 8 are flowcharts illustrating a control method of a vehicle in accordance with from a first to third embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments described in the present disclosure and configurations shown in the drawings are merely examples of the embodiments of the present disclosure, and may be modified in various different ways at the time of filing of the present application to replace the embodiments and drawings of the present disclosure.

Also, the terms used herein are used to describe the embodiments and are not intended to limit and/or restrict the present disclosure. The singular forms “a,” “an” and “the” are intended to include the plural forms as well, unless the context clearly indicates otherwise. In this present disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the present disclosure, a first element may be termed as a second element, and a second element may be termed as a first element. The term of “and/or” includes a plurality of combinations of relevant items or any one item among a plurality of relevant items.

In the description of the present disclosure, if it is determined that a detailed description of commonly-used technologies or structures related to the embodiments of the present disclosure may unnecessarily obscure the subject matter of the present disclosure, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

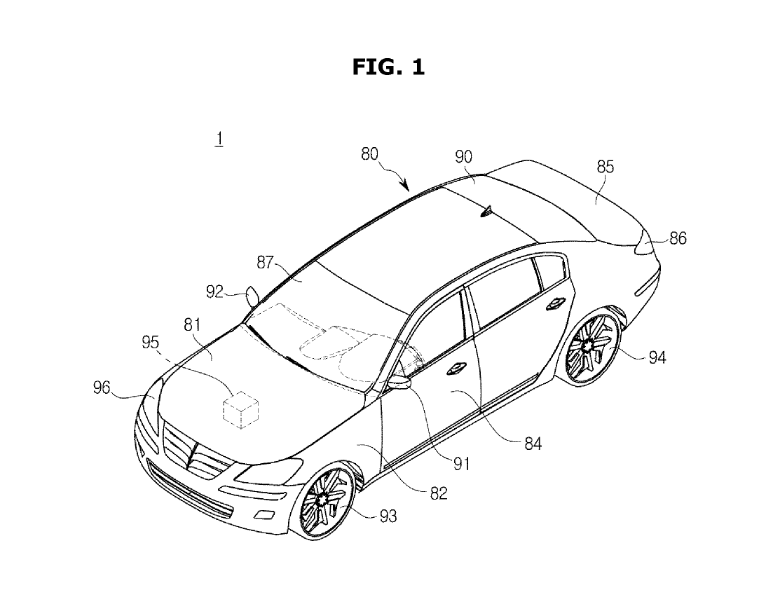

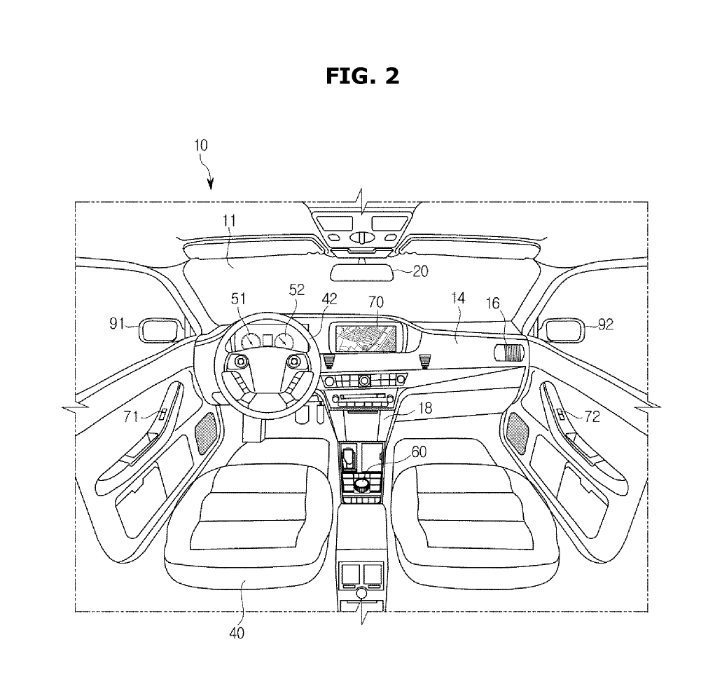

Hereinafter a vehicle in which the present disclosure is installed will be described with reference to FIGS. 1 and 2.

FIG. 1 is view illustrating an exterior of a vehicle in accordance with embodiments of the present disclosure.

As shown in FIG. 1, according to embodiments of the present disclosure, the vehicle 1 may include a body 80 forming an exterior of the vehicle 1, vehicle wheels 93 and 94 moving the vehicle 1, a driving device 95 rotating the vehicle wheels 93 and 94, a door 84 closing the inside of the vehicle 1 from the outside, a front glass 87 providing a front view of the vehicle 1 to a driver inside the vehicle 1, side mirrors 91 and 92 providing a view of a rear side of the vehicle 1 to the driver, and a rear window 90 provided in the rear side of the body 80 to provide view of the rear side of the vehicle 1. The body 80 may include a hood 81, a front fender 11, the door 84, a trunk lid 85 and a quarter panel 86.

The vehicle wheels 93 and 94 may include a front wheel 93 provided on a front of the vehicle and a rear wheel 94 provided on a rear of the vehicle. The driving device 95 may supply a torque to the front wheel 93 and the rear wheel 94 so that the body 80 may be moved forward and backward. The driving device 95 may employ an engine configured to generate a torque by burning fossil fuel or a motor configured to generate a torque by receiving power source from a capacitor (not shown).

The door 84 may be rotatably provided on a right side and a left side of the body 80. When the door 84 is opened, a driver may be allowed to be seated in the vehicle 1, and when the door 84 is closed, the inside of the vehicle 1 may be closed to from the outside.

The windscreen 87 may be provided on an upper portion of the front of the body 80 to allow the driver inside the vehicle 1 to acquire visual information about the front of the vehicle 1. The side mirrors 91 and 92 may include a left side mirror 91 provided on the left side of the body 80 and a right side mirror 92 provided on the right side of the body 80, and may allow the driver inside the vehicle 1 to acquire visual information of the lateral side and the rear side of the vehicle 1.

The vehicle 1 may further include a proximity sensor configured to detect an obstacle and another vehicle in the rear or lateral side, and a rain sensor configured to detect whether to rain and an amount of rain.

For example, the proximity sensor transmits a detection signal to a lateral side or a rear side of the vehicle and receives a signal reflected from an obstacle, e.g., another vehicle. In addition, the proximity sensor may determine whether an obstacle is present in the rear side of the vehicle 1 and a position in which the obstacle is present based on wave form of the reflected signal. The proximity sensor may employ a technology of irradiating ultrasonic waves and detecting a distance to an obstacle by using the reflected ultrasonic waves.

It should be understood the exterior of the vehicle 1 as described above and shown in FIG. 1 is provided merely for demonstration purposes, and does not limit the scope of the present disclosure.

FIG. 2 is a view illustrating an interior of the vehicle in accordance with embodiments of the present disclosure.

Hereinafter a configuration of the vehicle interior 10 will be described in details.

In the vehicle interior 10, a telematics terminal (not shown) may be installed for the communication with the outside. The telematics is a compound word of telecommunication and informatics, and the telematics represents a system that sends and receives e-mails in the vehicle or retrieves a variety of information through the Internet.

The telematics terminal may be provided with as a device having all the to functions of a computer, a wireless communication, and a satellite navigation system. Therefore, a driver can use the telematics terminal to access an external telematics server, and then use various functions such as exchanging data and images through the telematics server.

Although the telematics terminal is not necessarily seen by a driver, since the telematics terminal is embedded in the vehicle interior 10, the driver may generally use the function of the telematics through a display 70.

In the vehicle interior 10, an air conditioning device 16 may be installed. The air conditioning device 16 may represent a device configured to control automatically air conditioning environment including environment conditions in the inside or the outside of the vehicle 1, the intake and discharge, circulation, cooling and heating state of the air, or configured to control manually the air conditioning environment in response to a user's control command. The air conditioning device 16 may perform both of the cooling and heating and control the temperature of the vehicle interior 10 by discharging the heated or cooled air via a discharging port.

The vehicle interior 10 may include a dashboard 14 in which a variety of devices are installed to allow a driver to operate the vehicle 1, a driver seat 15 in which the driver is seated, and a cluster display 51 and 52 configured to display operation information of the vehicle 1.

The dashboard 14 may protrude from a lower side of the windscreen 11 to the driver so that the driver may operate a variety of devices installed in the dashboard 14 while staring at the front.

The driver seat 15 may be provided in a rear side of the dashboard 14 so that the driver may drive the vehicle 1 in a stable position while staring at the front and the variety of devices of the dashboard 14.

The cluster display 51 and 52 may be provided in the driver seat 15 of the dashboard 14 and include a speedometer 51 indicating a driving speed of the vehicle 1 and a revolutions per minute (RPM) gauge 52 indicating a rotation speed of a driving device (not shown).

The vehicle interior 10 may have an additional jog dial 60 to operate to drive a variety of devices. The jog dial 60 may perform an operation by being rotated or pressed, and may be provided with a touch pad having a touch recognition function to perform a handwriting recognition by using the user's finger or an additional device having a touch recognition function.

A steering system for the driving of the vehicle may include a steering wheel 42 receiving a driving direction from a driver, a steering gear (not shown) changing a rotary motion of the steering wheel 42 into a reciprocating motion, and a steering linkage (not shown) delivering the reciprocating motion of the steering gear (not shown) to the front wheel 93. Accordingly, the steering system may change the driving direction of the vehicle 1 by changing the direction of a rotating shaft of the wheels.

A brake system may include a brake pedal (not shown) receiving a brake operation from a driver, a brake drum (not shown) coupled to the vehicle wheels, and a brake shoe (not shown) stopping the rotation of the brake drum (not shown) by using friction force. Accordingly, the brake system may stop the driving of the vehicle 1 by stopping the rotation of the vehicle wheels.

It should be understood the interior of the vehicle 1 as described above and shown in FIG. 2 is provided merely for demonstration purposes, and does not limit the scope of the present disclosure.

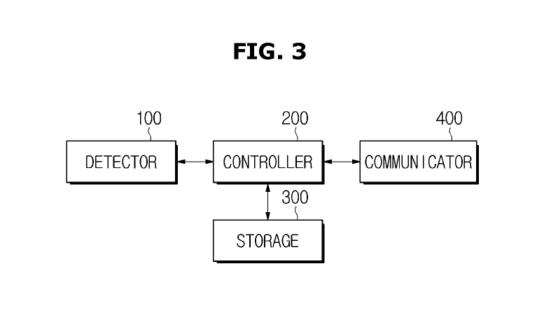

FIG. 3 is a block diagram illustrating a part of the configuration of the vehicle 1 in accordance with embodiments of the present disclosure.

As shown in FIG. 3, the vehicle 1 may include a detector 100 configured to detect a state of the vehicle 1, a controller 200 configured to control the vehicle 1 as a whole, a storage 300 configured to store information about intrusion detection items corresponding to a state of the vehicle 1, and a communicator 400 configured to perform a communication with a user terminal or a telephone management system (TMS) control center.

The detector 100 may detect a current state of the vehicle 1 in real-time and to then transmit a result of the detection to the controller 200.

Particularly, the detector 100 may detect the current state of the vehicle 1 including whether the current power of the vehicle 1 is turned on (ON) or turned off (OFF), whether an engine is operated or not, and whether the vehicle 1 drives or not. Therefore, the detector 100 may detect a state of the vehicle 1 in the state in which the power of the vehicle 1 is turned off (OFF), as well as in the state in which the power of the vehicle 1 is turned on (ON).

The controller 200 may determine whether the vehicle 1 is currently intruded from the outside, based on the detection result received from the detector 100 and an intrusion detection item corresponding to the state of the vehicle stored in the storage 300.

For the purpose of the present disclosure, an “intrusion” may include a case in which unauthorized persons physically break into the inside of the vehicle 1 and a case in which unauthorized persons intrude the system of the vehicle 1 by using an external network or a device.

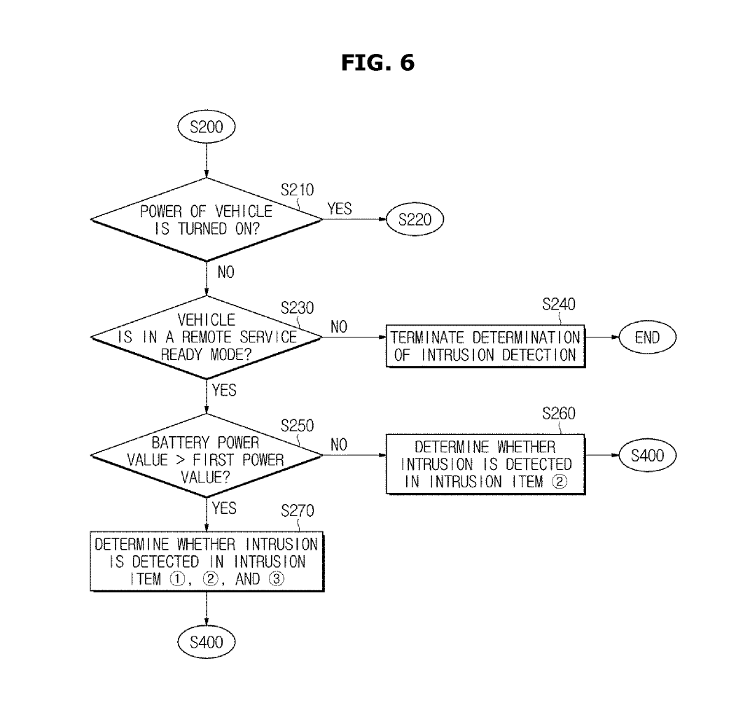

For example, the controller 200 may determine whether unauthorized persons intrude into the system of the vehicle via the telematics or a phone connectivity of the vehicle, whether the intrusion is performed via an external device connected to the vehicle 1, or whether the intrusion is performed via controller area network (CAN) or Ethernet that is in-vehicle communication. A detail description thereof will be described with reference to FIG. 6.

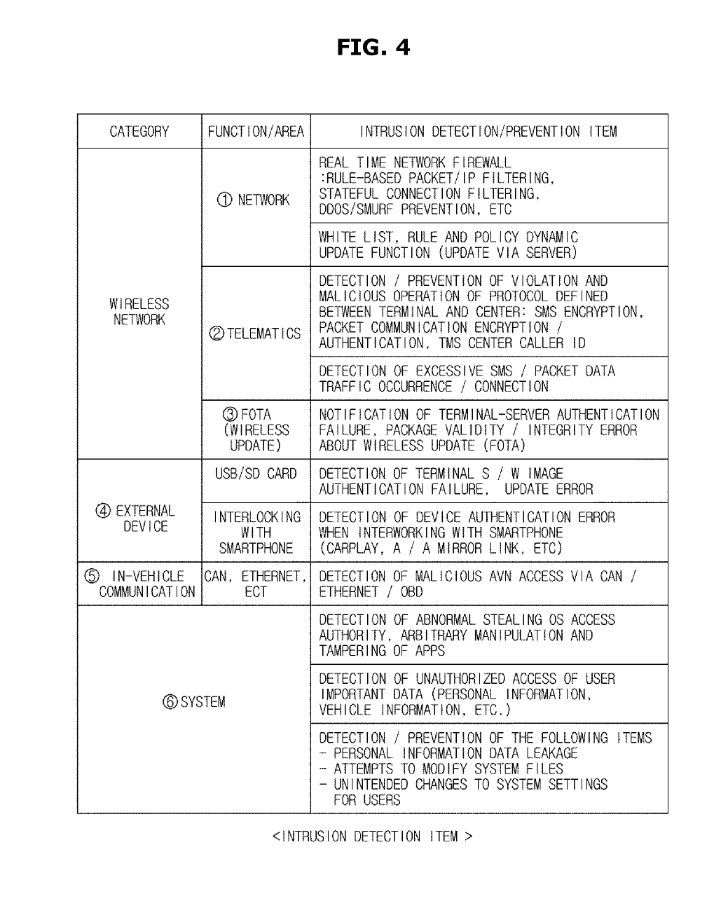

In the storage 300, the intrusion detection item, which is to be detected by corresponding to a variety of information about the vehicle 1 and the state of the vehicle 1, may be stored. Particularly, information shown in FIG. 4 may be stored in the storage 300, but is not limited thereto. Alternatively, a variety of information about the vehicle intrusion may be stored in the storage 300.

The storage 300 may include all types of recording media in which an instruction that can be decoded by a computer is stored. For example, the storage 300 may include read only memory (ROM), random access memory (RAM), a magnetic tape, a magnetic disk, a flash memory, and an optical data storage device.

The communicator 400 may transmit and receive a signal between the vehicle 1 and a user terminal or an external server.

Particularly, when the controller 200 determines that the vehicle intrusion is currently performed, the communicator 400 may inform the user terminal or telephone management system (TMS) control center of the intrusion. When the communicator 400 receives a command related to the intrusion, from the user terminal or telephone management system (TMS) control center, the communicator 400 may transmit the command to the controller 200.

FIG. 4 is a table illustrating an item to determine whether the vehicle intrusion is detected in accordance with embodiments of the present disclosure.

As mentioned above, the vehicle intrusion may be performed in a variety of methods, and thus when determining the vehicle intrusion, all items may be considered as possible as.

For example, as illustrated in FIG. 4, when determining whether an intrusion is performed related to a wireless network, it may be determined whether the intrusion is performed in a network area (item 1), a telematics area (item 2), and a wireless update (firmware over the air; (FOTA)) area (item 3), and when an external device connected to the vehicle 1 is present, it may be determined whether the intrusion is performed in an external device, a universal serial bus (USB), a SD card or a smart phone, which are connected to the vehicle 1.

In addition, it may be determined whether the intrusion is performed via in-vehicle communication, e.g., CAN communication or Ethernet communication, and it may be determined whether the intrusion is performed in a system for OS management (item 6).

When detecting whether the external intrusion is performed, it may be stable to determine whether the intrusion is performed, according to all items as illustrated in FIG. 4. However, depending on the situations, it may be effective to determine whether the intrusion is performed, according to some items, which are detectable.

That is, as for the vehicle 1, since the vehicle 1 has hardware and a processor having a relative lower performance than the general PC or a server, the determination of whether the intrusion is performed, according to all items as illustrated in FIG. 4 may lead the overload in the hardware and processor in the vehicle 1.

In addition, as for the vehicle 1, there may be a variety of states, e.g., a state in which the power is turned off (OFF), an accessory (ACC) state in which an engine is not operated although the power is turned on (ON), a state in which the engine is operated and the vehicle is driven, and a state in which the vehicle is stopped although the engine is operated. However, according to the conventional manner, the determination of the intrusion detection may be performed by uniformly applying the determination items about the intrusion detection, without considering the above mentioned various states. Accordingly, the intrusion detection may be inefficiently performed.

That is, when determining the vehicle intrusion is performed without considering the state of the vehicle, it may be determined whether the intrusion is performed, according to all items as illustrated in FIG. 4. and it may be inefficient.

However, according to embodiments of the present disclosure, by selectively determining whether the vehicle intrusion is detected according to a predetermined detection items corresponding to the current state of the vehicle, it may be possible to more effectively determine whether the vehicle intrusion is detected. A description thereof will be described in details with reference to the drawings.

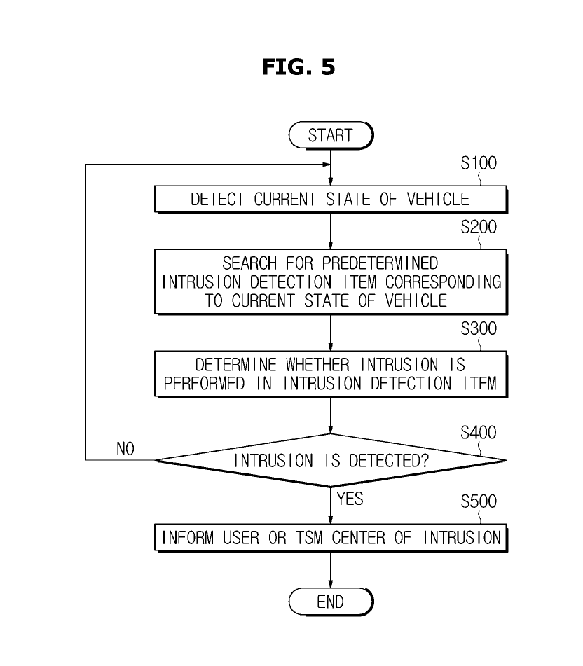

FIG. 5 is a flow chart illustrating a control method of the vehicle 1 in accordance with embodiments of the present disclosure.

As shown in FIG. 5, the vehicle 1 detects a current state of the vehicle 1 (100).

Particularly, the vehicle 1 may detect whether the power of the vehicle 1 is turned on (ON) or off (OFF), whether the vehicle is in the accessory (ACC) state in which the engine is not operated although the power is turned on (ON), or whether the engine is operated or not.

In addition, although the power of the vehicle 1 is turned off (OFF), the vehicle 1 may detect whether the vehicle 1 is in a remote service ready mode or not, and an amount of a battery of the vehicle 1.

In addition, although the engine is operated, the vehicle 1 may detect whether the vehicle 1 is started by a general ignition or by a remote ignition, and whether the vehicle 1 is driven.

When the detection of the current state of the vehicle 1 is completed, the vehicle 1 may search for the predetermined intrusion detection items corresponding to the current state of the vehicle 1 based on the detected information, and when items to be detected is present, the vehicle 1 may determine whether the intrusion is performed, according to the corresponding item (200 and 300)

Particularly, the vehicle 1 may selectively determine whether the intrusion is detected by using an intrusion target item, which is to be detected, corresponding to the state of the vehicle 1.

Although the vehicle 1 is capable of determining whether the intrusion is performed, according to all items as illustrated in FIG. 4, the vehicle 1 may determine whether the intrusion is performed, according to some items based on the state of the vehicle 1. For example, the vehicle 1 may determine whether the intrusion is performed, according to number 1 item and number 2 item, and whether the intrusion is performed, according to number 1 item to number 5 item. A detail description thereof will be described with reference to FIGS. 6 to 8.

When the intrusion is detected after the determination of whether the intrusion is performed according to the intrusion detection item, is completed, the vehicle 1 may inform the user or the TMS control center of the intrusion (400 and 500).

Although not shown in the drawings, after the vehicle 1 informs the user or the TMS control center of the intrusion, when the vehicle 1 receives a certain command from the user or the TMS control center, the vehicle 1 may control the environment of the vehicle 1 based on the received command.

When the intrusion is not detected in the step 400, the vehicle 1 may return to the step 100 so as to detect the current state of the vehicle 1.

Hereinbefore the operation procedure of the present disclosure has been schematically described with reference to FIG. 5. Hereinafter a procedure for determining differently the intrusion detection items based on the current state of the vehicle will be described with reference to the drawings.

FIGS. 6 to 8 are flowcharts illustrating a control method of a vehicle in accordance with from a first to third embodiments of the present disclosure.

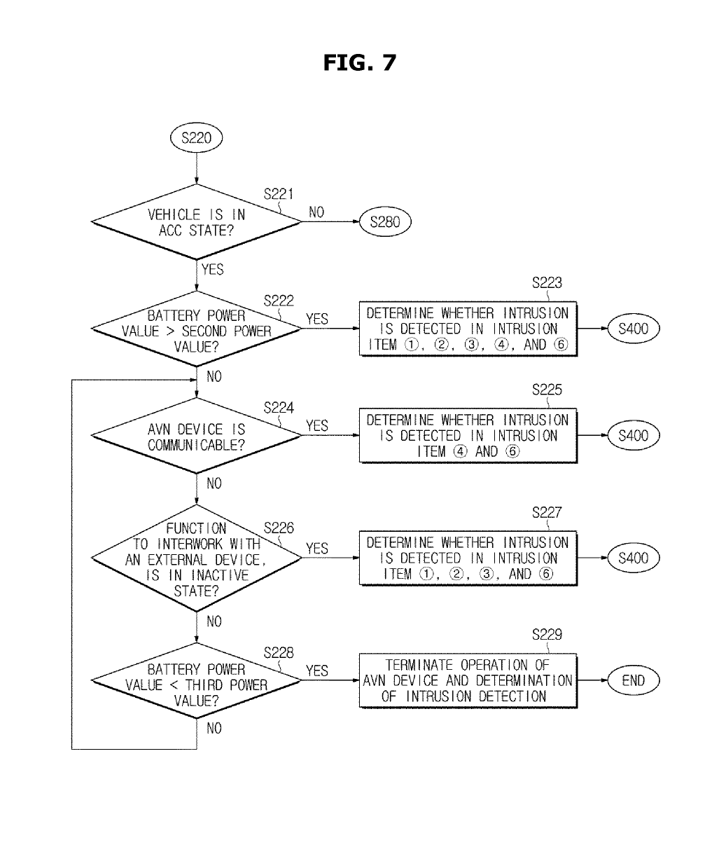

Particularly, FIG. 6 is a flowchart illustrating a procedure for determining whether the intrusion is performed, according to different intrusion detection items according to a detailed condition of the vehicle 1 in a state in which the power of the vehicle 1 is turned off (OFF), and FIG. 7 is a flowchart illustrating a procedure for determining whether the intrusion is performed, according to different intrusion detection items according to a detailed condition of the vehicle 1 in the ACC state in which an engine is not operated although the power of the vehicle 1 is turned on (ON).

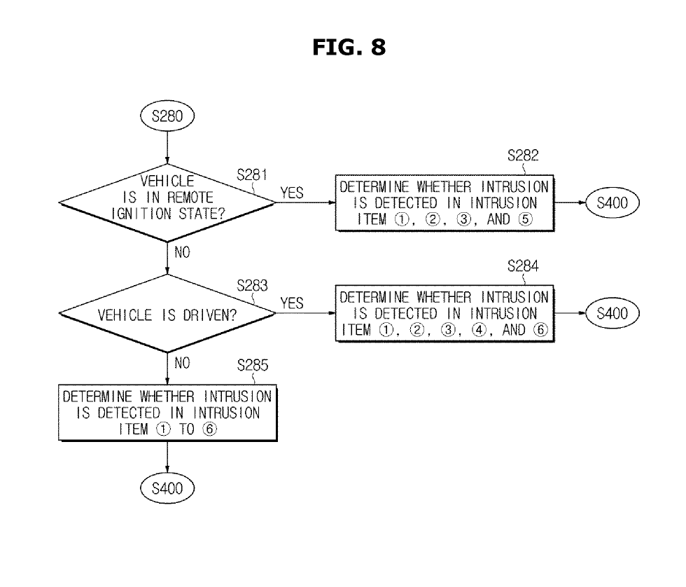

FIG. 8 is a flowchart illustrating a procedure for determining whether the intrusion is performed, according to different intrusion detection items according to a detailed condition of the vehicle 1 in a state the power of the vehicle 1 is turned on (ON) and the engine is operated.

Referring first to FIG. 6, the vehicle 1 may determine whether the power of the vehicle 1 is turned on (ON) when detecting the current state of the vehicle 1 (210).

When the power of the vehicle 1 is turned on, the vehicle 1 may go to a step 220 to determine whether the engine is operated, but when the power of the vehicle 1 is turned off (OFF), the vehicle 1 may determine whether the vehicle 1 is in the remote service ready mode or not (220 and 230).

Remote service ready mode may represent a state in which approximate three days (about 92 hours) is not expired after the power of the vehicle 1 is turned off (OFF), i.e., a state in which a user is able to remotely control the vehicle 1. In general, when the vehicle 1 is in the remote control ready mode, only wireless communication state may be activated.

When the remote control ready mode is released since 96 hours is passed after the power of the vehicle 1 is turned off (OFF), it may be assumed that all functions of the vehicle 1 is turned off (OFF). Therefore, in this case, it may be impossible to intrude to the inside of the vehicle 1 through the communication from the outside, and thus it may be possible to terminate the determination of the intrusion detection (240).

When the vehicle 1 is in the remote control ready mode, the vehicle 1 may determine whether a battery power value of the vehicle 1 exceeds a first predetermined power value (250).

In general, in a state in which the power of the vehicle 1 is turned off (OFF), when the vehicle 1 determines whether the intrusion is detected, according to many items, the battery consumption may increase and thus it may lead the discharge of the battery.

Accordingly, the step 250 is configured to prevent a case in which the battery of the vehicle 1 is discharged, and thus when the battery power value of the vehicle 1 is smaller than the first predetermined power value, the vehicle 1 may determine whether the intrusion is detected, according to the most needed item corresponding to a telematics item (item \textcircled{2} of FIG. 4).

When the battery power value of the vehicle 1 is higher than the first predetermined power value, it may be less likely to discharge the battery when determining whether the intrusion is detected, according to many items. Therefore, in this case, the vehicle 1 may determine whether the intrusion is detected, according to a network item (item \textcircled{1} of FIG. 4), the telematics item (item \textcircled{2} of FIG. 4), a wireless update item (item \textcircled{3} of FIG. 4).

The first power value may represent a power value that is highly likely to discharge power of the battery since the power value of the battery is not much left, and thus it is not limited to a certain power value. Therefore, the first power value may vary according to the state of the vehicle 1 or the environment of the user.

FIG. 7 is a flowchart illustrating a procedure for determining whether the intrusion is detected in the state in which the engine is not operated although the power is turned on (ON) according to a step 210.

Referring next to FIG. 7, when the power of the vehicle 1 is not turned on (ON), the vehicle 1 may determine whether the state of the vehicle 1 is in the ACC state or not (221).

Accessory (ACC) state may represent a state in which the engine is not operated although the power of the vehicle 1 turned on (ON). In this case, although the engine is not operated, the vehicle 1 may determine whether the intrusion is detected by using a variety of methods according to the environment of the vehicle.

When the power of the vehicle 1 turned on (ON), and the vehicle 1 is not in the ACC state, the engine of the vehicle 1 may be operated and thus the procedure may go to a step 280. When the vehicle 1 is in the ACC state, the vehicle 1 may determine whether the battery value of the vehicle 1 exceeds a second power value (222).

As mentioned in the step 250, the step 222 is configured to determine whether the intrusion is detected, according to items by considering the discharge possibility of the vehicle 1, and thus when the battery power value of the vehicle 1 exceeds the second power value, it may less likely to discharge the battery and thus it may be possible to determine whether the intrusion is detected, according to many items.

Particularly, the vehicle 1 may determine whether the intrusion is detected, according to a network item (item \textcircled{1} of FIG. 4), the telematics item (item \textcircled{2} of FIG. 4), a wireless update item (item \textcircled{3} of FIG. 4), an external device item (item \textcircled{4} of FIG. 4), and a system item (item \textcircled{6} of FIG. 4).

The second power value may represent a power value that is highly likely to discharge power of the battery since the power value of the battery is not much left, and thus it is not limited to a certain power value.

The second power value and the first power value may be set as the same value or alternatively, set as a different value according to the environment thereof.

When the power value of the battery is less than the second power value, the vehicle 1 may determine whether the Audio, Video, Navigation (AVN) device in the vehicle 1 is communicable or not (224).

When the communication of the AVN device is available, in order to minimize the power consumption of the AVN device and simultaneously to improve the efficiency of the determination of the intrusion detection, the vehicle 1 may determine whether the intrusion is detected, according to the external device item (item \textcircled{4} of FIG. 4), and the system item (item \textcircled{6} of FIG. 4) (225).

When the communication of the AVN device is not available, the vehicle 1 may determine whether a function, which is to interwork with an external device, is in an inactive state (226).

When the communication of the AVN device is in the inactive state, in order to improve the efficiency of the determination of the intrusion detection, the vehicle 1 may determine whether the intrusion is detected, according to a network item (item \textcircled{1} of FIG. 4), the telematics item (item \textcircled{2} of FIG. 4), the wireless update item (item \textcircled{3} of FIG. 4), and the system item (item \textcircled{6} of FIG. 4).

When the communication of the AVN device is in the active state, there may be a possibility of the discharge of the battery and thus the vehicle 1 may determine whether the current power value of the battery is less than a third power value (228).

The third power value may represent a power value that is highly likely to discharge power of the battery but is not limited to a certain power value. Therefore, the third power value may vary according to the environment of the vehicle 1 and the preference of the user.

When the detected power value of the battery is less than the third power value, it may be highly likely to discharge the battery and thus, in order to prevent the discharge, the vehicle 1 may stop the operation of the AVN device and terminate the determination of the intrusion detection (229).

FIG. 8 is a view illustrating a procedure for determining whether the intrusion is performed in a state the power of the vehicle is turned on (ON) and the engine is operated according to the step 221.

Referring next to FIG. 8, when the power of the vehicle is not turned on (ON), the vehicle 1 may determine whether the vehicle is in a remote ignition state (281).

Particularly, when the vehicle is in the remote ignition state, the operation of the AVN device of the vehicle 1 may be not operated and the vehicle 1 may determine whether the intrusion is detected, according to the network item (item \textcircled{1} of FIG. 4), the telematics item (item \textcircled{2} of FIG. 4), the wireless update item (item \textcircled{3} of FIG. 4), and an in-vehicle communication item (item \textcircled{5} of FIG. 4).

When the vehicle 1 is in a general ignition state without in the remote ignition state, the vehicle 1 may determine whether the vehicle 1 is driven or not (283).

Particularly, when the vehicle 1 is not driven, the vehicle 1 may determine whether the intrusion is detected, according to the network item (item \textcircled{1} of FIG. 4), the telematics item (item \textcircled{2} of FIG. 4), the wireless update item (item \textcircled{3} of FIG. 4), the external device item (item \textcircled{4} of FIG. 4), and the system item (item \textcircled{6} of FIG. 4) (284).

When the vehicle 1 is driven, the vehicle 1 may determine whether the intrusion is detected, according to the network item (item \textcircled{1} of FIG. 4), the telematics item (item \textcircled{2} of FIG. 4), the wireless update item (item \textcircled{3} of FIG. 4), the external device item (item \textcircled{4} of FIG. 4), the in-vehicle communication item (item \textcircled{5} of FIG. 4), and the system item (item \textcircled{6} of FIG. 4) (285).

Hereinbefore the configuration and the control method of the vehicle has been described with reference to the drawings according to embodiments of the present disclosure.

According to conventional techniques, as for the network firewall or IDS system installed in the vehicle, the determination of whether the intrusion is detected in the vehicle may be performed according to the uniform standard without the consideration of the power state, ignition state, and the driving state of the vehicle. Accordingly, there may be difficulties in efficiently determining whether the intrusion is detected.

However, according to embodiments of the present disclosure, the vehicle determines whether the intrusion is detected, by changing the intrusion detection items based on the current state of the vehicle when determining whether the intrusion is performed or not. Accordingly, it is possible to more actively and effectively determine whether the vehicle is intruded or not.

Although certain embodiments of the present disclosure have been shown and described, it would be appreciated by those skilled in the art that changes may be made in these embodiments without departing from the principles and spirit of the disclosure, the scope of which is defined in the claims and their equivalents.

### DESCRIPTION OF SYMBOLS

100: detector
200: controller
300: storage
400: communicator

What is claimed is:

1. A vehicle comprising:
a detector detecting a state of the vehicle; and
a controller determining whether a vehicle intrusion is detected based on the detected state of the vehicle,
wherein the controller determines whether the vehicle intrusion is detected according to a predetermined intrusion detection item corresponding to the state of the vehicle.

2. The vehicle of claim 1, wherein
the controller determines whether the vehicle intrusion is detected based on a power state of the vehicle.

3. The vehicle of claim 1, wherein,
when the vehicle is turned off, the controller determines whether the vehicle intrusion is detected according to at least one of a network item, a telematics item, and a wireless update item.

4. The vehicle of claim 1, wherein,
when a battery power value of the vehicle is less than a first power value, the controller determines whether the vehicle intrusion is detected according to a telematics item.

5. The vehicle of claim 1, wherein,
the controller determines whether the vehicle intrusion is detected based on an engine state of the vehicle.

6. The vehicle of claim 1, wherein,
when an engine of the vehicle is turned on by a remote ignition, the controller determines whether the vehicle intrusion is detected according to at least one of a wireless network item, a telematics item, a wireless update item, and an in-vehicle communication item.

7. The vehicle of claim 1, wherein,
when the vehicle is in an accessory (ACC) state, the controller determines whether the vehicle intrusion is detected based on at least one of a battery state of the vehicle and a state of an audio, video, navigation (AVN) device.

8. The vehicle of claim 1, wherein,
when a battery power value of the vehicle is higher than a second power value, the controller determines whether the vehicle intrusion is detected according to at least one of a wireless network item, a telematics item, a wireless update item, and an item related to an external device connected to the vehicle.

9. The vehicle of claim 1, wherein,
when communication of an AVN device of the vehicle is not available, the controller determines whether the vehicle intrusion is detected according to at least one of an item related to an external device connected to the vehicle and a vehicle item.

10. The vehicle of claim 1, wherein,
when the vehicle is in a remote service ready mode after power of the vehicle is turned off, or when a battery power value of the vehicle is less than a third power value while the vehicle is in an ACC state, the controller does not determine whether the vehicle intrusion is detected.

11. The vehicle of claim 1, further comprising:
a communicator informing a user of the vehicle or a telephone management system (TMS) control center of the vehicle intrusion when it is determined by the controller that the vehicle intrusion is detected.

12. A control method of a vehicle comprising:
detecting, by a detector, a state of the vehicle; and
determining, by a controller, whether a vehicle intrusion is detected based on the detected state of the vehicle,
wherein the determination of whether the vehicle intrusion is detected comprises determining whether the vehicle intrusion is detected according to a predetermined intrusion detection item corresponding to the state of the vehicle.

13. The control method of claim 12, wherein
the determination of whether the vehicle intrusion is detected comprises determining whether the vehicle intrusion is detected based on a power state of the vehicle.

14. The control method of claim 13, wherein
the determination of whether the vehicle intrusion is detected comprises, when the power of the vehicle is turned off, determining whether the vehicle intrusion is detected, according to at least one of a network item, a telematics item, and a wireless update item.

15. The control method of claim 12, wherein
the determination of whether the vehicle intrusion is detected comprises, when the battery power value of the vehicle is less than a first power value, determining whether the vehicle intrusion is detected, according to a telematics item of the vehicle.

16. The control method of claim 12, wherein
the determination of whether the vehicle intrusion is detected comprises determining whether the vehicle intrusion is detected based on an engine state of the vehicle.

17. The control method of claim 12, wherein
the determination of whether the vehicle intrusion is detected comprises, when an engine of the vehicle is turned on by a remote ignition, determining whether the vehicle intrusion is detected, according to at least one of a wireless network item, a telematics item, a wireless update item, and an in-vehicle communication item.

18. The control method of claim 12, wherein
the determination of whether the vehicle intrusion is detected comprises, when the vehicle is in an accessory (ACC) state, determining whether the vehicle intrusion is detected, based on at least one of a battery state of the vehicle and a state of an audio, video, navigation (AVN) device.

19. The control method of claim 12, wherein
the determination of whether the vehicle intrusion is detected comprises, when a battery power value of the vehicle is higher than a second power value, determining whether the vehicle intrusion is detected according to at least one of a wireless network item, a telematics item, a wireless update item, and an item related to an external device connected to the vehicle.

20. The control method of claim 12, wherein
the determination of whether the vehicle intrusion is detected comprises, when communication of an AVN device of the vehicle is not available, determining whether the vehicle intrusion is detected according to at least one of an item related to an external device connected to the vehicle and a vehicle item.
